(19) United States
(12) Patent Application Publication
(10) Pub. No.: US 2005/0223615 A1
(43) Pub. Date: Oct. 13, 2005

(54) Wind activated decoy

(76) Inventors: Jeffery J. Fencel, Bethalto, IL (US); Matthew J. Baalman, Hardin, IL (US)

Correspondence Address: BRYAN CAVE LLP, 211 NORTH BROADWAY, SUITE 3600, ST. LOUIS, MO, 63102-2750, US

(21) Appl. No.: 10/821,340

(22) Filed: Apr. 9, 2004

(51) Int. Cl. A01M 31/06

(52) U.S. Cl. 43/3

(57) ABSTRACT

The present invention provides wind activated hunting decoys. More particularly, the invention provides wind activated hunting decoys, which comprise a body portion adapted to portray realistic images of any waterfowl or other decoy species. The invention further provides universal mounting posts upon which the wind activated decoys are supported. The universal mounting posts, preferably, can be used with any accommodating body portion of such wind activated decoys.

### FIELD OF THE INVENTION

The present invention relates generally to the sport of wildfowl hunting, and more specifically to decoys having wind activated vanes or simulated wings.

### BACKGROUND OF THE INVENTION

Decoys, lures and the like have been used by hunters to attract game from the beginnings of the activity. Hunters have recognized that relatively crude decoys and the like are not particularly effective, but have employed such crude decoys as being better than nothing. More recently, relatively sophisticated decoys using audioanimatronic principles have been developed, with such decoys serving to attract and fool game animals to a much greater extent than earlier, relatively simple decoys and lures.

However, such relatively sophisticated decoys, with their electrically operated components, tend to be relatively fragile, particularly in the outdoor environment where they are subject to temperature extremes, moisture, etc. Such complex decoys are also relatively expensive to purchase, as well as to maintain. In addition, such decoys have come under increasing regulation, including prohibitions on use, in several states. As a result, they have never found great favor among hunters and others who wish to use decoys to attract game animals.

Nonetheless, the provision of a decoy which employs some periodic movement is desirable. Most animals are attuned to detect movement before detecting most other visual cues (color, contrast, etc.). While some aspects of movement may startle game animals, a movement which is relatively natural in its appearance is desirable, particularly if the movement can be achieved without complex and costly electromechanical mechanisms.

Accordingly, hunters will benefit from decoys employing simulated wings deployed laterally from the body of such decoys. The simulated wings, preferably, extend laterally on rotary shafts, which are in turn mounted through such decoy bodies on roller or ball bearings to provide an extremely low friction attachment. Thus, the slightest breeze causes the two wings to rotate upon the rotary shaft, with the result having an appearance from some distance away much like the wing beat of a bird alighting.

The body of the decoy is mounted upon a generally vertical post, which allows the decoy to pivot to face into the wind in a realistic manner, while also providing more efficient airflow to the wings. The body of the decoy and vertical post, preferably, comprise distinct and separate objects. In certain preferred embodiments, realistic bird-like images may be screen printed on the body of the decoy, which can then be attached to the generally vertical post.

A discussion of the related art of which the present inventors are aware, and its differences and distinctions from the present invention, is provided below.

U.S. Pat. No. 2,441,753 issued on May 18, 1948 to Gurdeon E. Carpenter, titled “Duck Decoy,” describes a silhouette or profile type decoy formed of a single relatively thin sheet of plywood or other suitable material. The decoy shape and markings generally present the appearance of a bird viewed from above, with wings outspread. The entire apparatus is pivotally balanced upon a stake which is in turn driven into the underlying surface to support the decoy and allow it to pivot into the wind. Movement of the decoy about its pivot simulates a gliding bird with outspread wings. However, the Carpenter decoy is a single monolithic unit with no relatively movable wings, whereas the present decoy with its wind activated rotary vanes serves to simulate the wing beat of an alighting bird, which cannot be accomplished with the fixed wings of the Carpenter decoy.

U.S. Pat. No. 2,638,705 issued on May 19, 1953 to Albert W. Petrasy, titled “Ornamental Bird Having Rotatable Wings,” describes a simulated bird having a profile body with a short wing support shaft rotatably installed laterally through the body. A wing attachment arm is affixed to each end of the lateral shaft, with a wing panel extending from each attachment arm. The wing panels are each twisted, so as to provide a pitch angle or angle of attack when presented to the wind. The resulting apparatus is related to a propeller, but with the blade attachments being longitudinally offset from one another on the propeller shaft, rather than being in the same plane. The apparatus thus does not resemble the present decoy with its rotary wing vanes having their elongate axes disposed along a single lateral axis.

U.S. Pat. No. 3,707,798 issued on Jan. 2, 1973 to Ned A. Tryon, titled “Decoy,” describes a decoy formed of a pair of flat elements assembled in a cruciform configuration. The vertically disposed element resembles a silhouette of a goose body, while the horizontally disposed element represents the width of the body when viewed from above. The assembly is mounted atop a stake which is driven into the underlying surface to support the decoy. No relatively movable components are provided by Tryon for his decoy. No movable wing vanes or pivoted mounting are provided by Tryon, in contrast to the pivoted mounting and rotating wing vanes of the present wind activated decoy.

U.S. Pat. No. 4,620,385 issued on Nov. 4, 1986 to Thomas G. Carranza et al., titled “Rotatable Wings For Water Fowl Decoys,” describes a simulated wing assembly in which each wing comprises four rotary vanes extending from a common lateral shaft. The shaft is immovably affixed to the mounting harness, with the wing vane assemblies extending from tubes which in turn rotate independently relative to one another upon the shaft. In contrast, the present wind activated decoy attaches the wings to a single common shaft, with the shaft rotating within low friction bearings disposed within a lateral passage through the mounting post to which the decoy body is attached.

A major advantage of the present decoy in comparison to the Carranza et al. decoy is that the opposite wings of the present decoy have a fixed relationship, with their planes disposed at a fixed angle of, preferably, forty five degrees from one another. This relationship assures that the wings will always have a synchronous relationship, just as the wings of a real waterfowl would likely have as the bird flapped its wings while alighting, and also precludes any singularity where air pressure on the wings equalizes to preclude rotation. The planform of the wings of the present decoy is also more realistic than the rectangular planform of the wings of the Carranza et al. decoy. Moreover, the Carranza et al. decoy requires a relatively thick body in order to support the wing attachment harness or frame, thus adding to the cost of the apparatus. The present wind activated decoy utilizes a silhouette or profile body, which greatly reduces the cost of the decoy while reducing realism only slightly when viewed from an oblique angle at some distance away.

U.S. Pat. No. 4,651,457 issued on Mar. 24, 1987 to Robert D. Nelson et al., titled “Decoy,” describes a silhouette head and neck portion with a pneumatically inflatable body portion extending therefrom. The head and neck portion is pivotally attached to a stake to allow the assembly to rotate in a breeze. However, the Nelson et al. decoy has no relatively movable wing panels to simulate the flight motion of a real bird, as does the present wind activated decoy. The Nelson et al. decoy only simulates a bird which is feeding, rather than one which is in flight and alighting on the surface, as in the case of the present wind activated decoy.

U.S. Pat. No. 4,656,768 issued on Apr. 14, 1987 to James C. Thigpen, titled “Wind Driven Sign,” describes a character having a silhouette body with opposed wind driven arms each affixed to its own independent lateral shaft. The general configuration is more closely related to that of the decoy of the Petrasy '705 U.S. Patent, discussed further above, than to the present invention. No lateral vanes are provided by Thigpen to simulate horizontally spread wing panels, in contrast to the present wind activated decoy invention.

U.S. Pat. No. 5,003,722 issued on Apr. 2, 1991 to Robert D. Berkley et al., titled “Flying Game Bird Decoy,” describes a decoy having a flat planform formed of thin sheets of foam plastic material mounted on a stake. The flexible sheet foam material allows the wing panels to move to simulate flight. However, no rotary motion is provided for the wing panels, nor is any realistic appearance provided from the side, due to the flat sheet elements.

U.S. Pat. No. 5,144,764 issued on Sep. 8, 1992 to Timothy D. Peterson, titled “Decoy With Wind-Actuated Wings,” describes a decoy formed almost entirely of flexible materials. The body portion comprises a hollow fabric tube, serving as a wind sock. The wing panels are activated by the wind to flap in a breeze, simulating a flying bird. However, no rotary motion of the wing panels is provided by Peterson, in contrast to the present decoy. The wing panels of the Peterson decoy are formed of thin, flexible sheet elements with wire or other stiffening rods. The rods hold the wings outspread, while allowing them to flap upwardly and downwardly in a wind. The inflatable body portion and flexible wing elements of the Peterson decoy are unlike the present decoy.

U.S. Pat. No. 5,283,088 issued on Feb. 1, 1994 to Dorothy H. Alcorn, titled “Bird Figure,” describes a simulated hummingbird having a profile body and laterally disposed rotating wings. Each wing panel is formed of a. single, generally star-shaped element folded to provide a series of six wing panels extending radially from a lateral axis. Alcorn states that the wing panels rotate in a breeze, but she does not provide any aerodynamic curvature to generate any aerodynamic forces upon the panels. In contrast, the present wind activated decoy includes relatively easily fabricated rotary wing vanes, each formed of a single sheet of material having a substantially sinusoidal cross sectional shape to generate aerodynamic forces for rotation. Moreover, Alcorn suspends her hummingbird model from a string, which is impracticable for a decoy used in the field.

U.S. Pat. No. 5,682,702 issued on Nov. 4, 1997 to Craig T. McKnight et al., titled “Collapsible Bird Decoy,” describes a structure formed of a series of relatively thin, flat panels secured orthogonally together to provide an assembly having a somewhat three dimensional appearance. The wing panels are flexible in order to flap in a breeze, and the assembly is pivotally mounted atop a stake in order to align itself with the breeze. No rotary motion is provided for the wing panels. The resulting structure is thus more closely related to the decoys of the Berkley et al. '722 and Peterson '764 U.S. Patents, than to the present wind activated decoy invention.

U.S. Pat. No. 5,862,619 issued on Jan. 26, 1999 to Jeffrey T. Stancil, titled “Animated Water Fowl Decoy,” describes a decoy having a three dimensional body with a frame disposed thereabove. A laterally disposed rotary wing shaft extends across the frame, with a single rotary wing installed on the shaft. The Stancil decoy is in some respects relatively more costly and complex than the present decoy, in that Stancil provides a three dimensional body for his decoy. Yet, the wing provided for the Stancil decoy is relatively primitive and unrealistic, with its frame mounted above the decoy body and single, laterally continuous span supported by each wing tip. In contrast, the present decoy wings provide considerably greater realism, with their individual spans extending to each side of the decoy body.

U.S. Pat. No. 6,092,323 issued on Jul. 25, 2000 to Craig M. McBride et al., titled “Duck Decoy,” describes a decoy with a rotary wing assembly extending to each side thereof. The decoy body is three dimensional and is supported by a central stake, with the outboard ends of the wing panels supported by lateral extensions of the stake. The McBride et al. wing assembly is not a cantilever structure with unsupported outer tips, as is the present decoy wing with its more realistic cantilever structure. Moreover, McBride et al. do not provide any means for their decoy to pivot about the vertical axis of the mounting stake to allow their decoy to pivot into the wind, whereas the present decoy can pivot freely into the wind according to variation in the wind direction in order to orient the airflow properly to activate the wing action and for greater realism.

U.S. Pat. No. 6,170,188 issued on Jan. 9, 2001 to Robert F. Mathews, titled “Apparatus For Attracting Waterfowl,” describes a decoy having a superficial resemblance to the present decoy. The Mathews decoy requires a three dimensional body, as the device contains a motor to provide power to the rotary wings. As Mathews prefers to provide power for wing rotation, he does not provide any means for his decoy to pivot into the wind, as is evidenced by its attachment to a series of square section tubes which cannot rotate relative to one another. Moreover, such motorized decoy mechanisms are not universally legal for hunting, whereas the present wind activated decoy mechanism is legal and is considerably less costly to purchase and maintain than such motorized decoy mechanisms.

Canadian Patent Publication No.1,050,268 published on Mar. 13, 1979 to Marvin Snow, titled “Water Fowl Decoy,” describes a decoy having a folding and flapping wing mechanism which may be remotely actuated by lines or cords. The wings of the Snow decoy are rigid panels, pivotally hinged to each side of the decoy body. The wings do not rotate about a lateral or any other axis extending from the body, as do the rotating wings of the present decoy. Moreover, the wings of the Snow decoy must be actuated manually. They do not operate automatically due to airflow from a wind or breeze, as is the case with the present wind actuated decoy.

Canadian Patent Publication No. 2,177,498 published on Nov. 29,1997 to Philippe Dupuis, titled “Hunting Decoy,” describes a flat panel decoy closely resembling that of the '798 U.S. Patent to Tryon, discussed further above. As in the Tryon decoy, the Dupuis decoy does not provide any wing movement.

Finally, U.S. Pat. No. 6,574,904 issued on Jun. 10, 2003 to the inventors, Jeffery J. Fencel et al., titled “Wind Activated Decoy,” also describes a decoy having a superficial resemblance to the present decoy. As will be shown below, however, the decoy of the present invention comprises many, significant improvements over the decoy of the '904 patent. In particular, the body portion and structural support for the decoy of the '904 patent are “molded” for “formed” into a single unit, i.e., the body portion and structural support cannot be interchanged. The structural support of the present decoy, referred to herein as the “mounting post,” is formed apart from the decoy body portion, which provides many significant advantages as will be discussed below.

In light of the foregoing, none of the above inventions and patents, either singly or in combination, describes the present invention as claimed herein.

### SUMMARY OF THE INVENTION

The wind activated decoy of the present invention essentially comprises a body portion that resembles the profile or silhouette of any wildfowl of interest. The body portion includes a lateral passage, which receives one side of a supportive mounting post. The body portion, preferably, can be imprinted with realistic wildfowl-like images, for example, wherein such images may represent photographic, computer-generated, or hand-painted renderings of the wildfowl of interest.

The mounting post of the present decoy removably supports a rotary wing shaft therein. The mounting post, preferably, comprises suitable bearings to facilitate rotation of the wing shaft. The wing shaft, preferably, includes a first permanently installed wing vane and a second removable wing vane, allowing the second vane to be removed from the shaft for removal of the shaft from the mounting post for compact storage of the components. In other embodiments, both wing vanes are removable from the wing shaft or, alternatively, both wing vanes are permanently installed on the wing shaft which may be used with appropriately configured mounting posts as described herein.

The mounting post of the present decoy further includes a support shaft, which is removably inserted into a tube (pipe or conduit, etc.), which is in turn driven into the underlying surface (dry ground, pond floor, marsh, etc.). The support shaft is positioned in such a way to allow the decoy to pivot about the support shaft to face the prevailing breeze, which orients the decoy for actuation of its rotary wing vanes. The ability of the present decoy to pivot into the prevailing wind allows it to simulate the behavior of real birds, which are known to face into the prevailing breeze or wind.

The mounting post of the present invention is, preferably, capable of supporting a plurality of different decoy body portions. That is, the mounting post of the present decoy is “universal” in that it can be used in connection with any appropriately configured decoy body portion. Thus, the “universal” nature of the mounting post simplifies manufacturing processes in that only one mounting post must be manufactured to create a plurality of different decoys, which may portray a plurality of different wildfowl. The interchangeability of the “universal” mounting post with various decoy body portions, of course, provides more options to the end users of the present decoys.

The wing vanes of the present decoy rotate in response to a prevailing breeze. Each wing vane comprises a thin, rigid sheet of material having, preferably, a sinusoidal cross section in order to facilitate its rotation in even a slight breeze. The two wing vanes, preferably, are secured upon the wing shaft at approximately a forty five degree angle to one another, in order to avoid any singularity, wherein aerodynamic pressures are equalized such that rotation of the wing vanes is stalled. In certain alternative embodiments, the two wing vanes are secured at any other angle (or no angle) to one another.

The opposite surfaces of each wing vane, preferably, are colored and/or textured to resemble the upper and lower wing surfaces of the desired waterfowl (duck, goose, etc., depending upon the type of bird being simulated). As the wing vanes rotate, they simulate the appearance of the rapid flapping of the wings of a bird alighting upon a surface. Thus, the present decoy is (i) realistic in appearance and action, (ii) inexpensive to manufacture, (iii) quickly deployed and removed in the field as desired, and (iv) can be easily adapted to portray any desired waterfowl using the “universal” mounting post described herein.

### BRIEF DESCRIPTION OF THE DRAWINGS

FIG. 1: A perspective view of the present wind activated decoy, showing the general relationship among its components.

FIG. 2: A perspective view of the mounting post.

FIG. 3: A side view of the mounting post of FIG. 2.

FIG. 4: A schematic end view of the rotary wing vanes, showing their angular offset from one another and rotational operation.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

The present invention is a decoy having wind activated rotary wings, simulating the appearance of the rapid flapping motion which occurs when a waterfowl or other bird is about to alight upon a surface. The present decoy utilizes relatively inexpensive and easily manufactured components, with the wing action being driven by relatively light breezes. The preferred angular relationship between the wing vanes eliminates any singularity which might occur, thus allowing the wings to rotate continually whenever sufficient breeze is present.

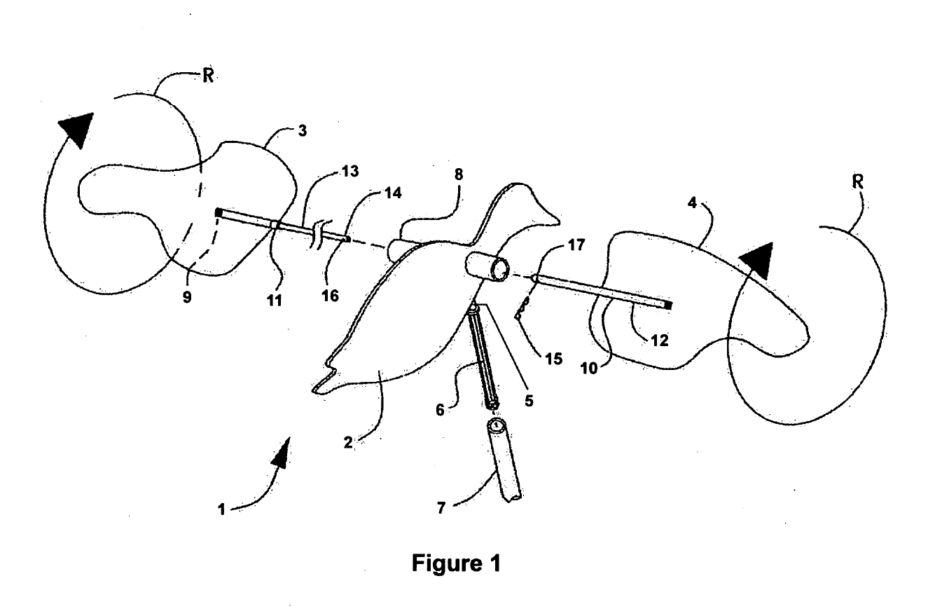

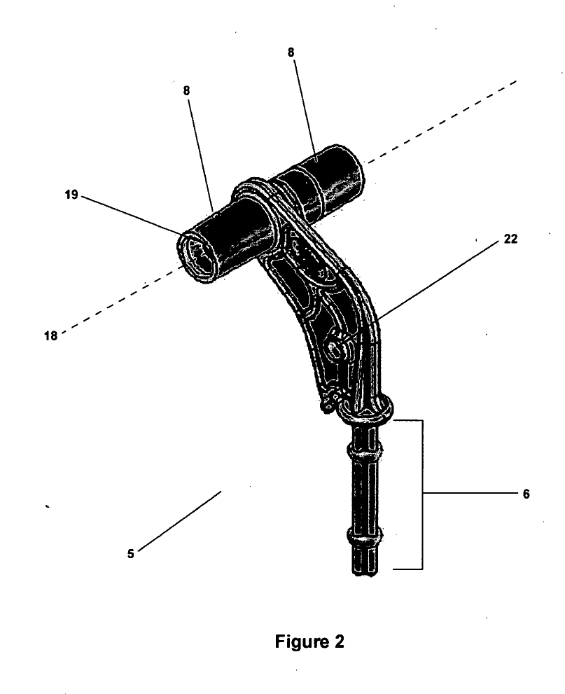

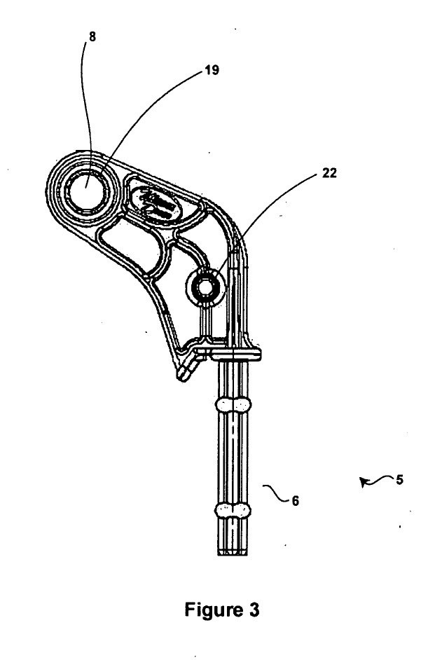

Referring to FIG. 1, the decoy 1 of the present invention comprises a profile or silhouette body portion 2 with a left and a right wing vane, respectively 3 and 4, extending laterally therefrom. The two wing vanes 3 and 4 are immovably affixed to one another when installed upon the decoy 1, with their common central shaft rotating within a lateral wing support structure 8 (or “lateral wing support tube”) (FIGS. 2 and 3), which passes through the mounting post 5. The wing vanes 3 and 4 thus rotate in the same direction, as indicated by the rotational arrows R in FIG. 1.

The body portion 2 of the present decoy is supported by the mounting post 5, which is supported by the support shaft 6. The support shaft 6 installs removably within a support tube 7, to allow the decoy 1 to pivot into the prevailing breeze. The decoy body portion 2 is formed of a relatively thin and rigid sheet of material, having the outline or shape of the desired wildfowl or game bird. The body portion 2 may be made of any suitable material, but plastic is preferred for its relatively light weight, corrosion resistance, and economy. The body portion 2 may, optionally, include additional stiffeners or reinforcement elements.

It is further contemplated that the decoy 1 may comprise two body portions 2. In this embodiment, each body portion 2 is secured to opposite sides of the mounting post 5. For example, the lateral passage of one body portion 2 receives one side of the lateral wing support structure 8 of the mounting post 5, i.e., the side of the mounting post 5 near the left wing vane 3. Similarly, the lateral passage of the second body portion 2 receives the other side of the lateral wing support structure 8 of the mounting post 5, i.e., the side of the right wing vane 4. Both body portions 2 may then be secured to the mounting post 5 as discussed below.

The profile or silhouette of the body portion 2 may be configured to resemble any species of bird or animal that may be used to attract the targeted waterfowl. The body portion 2 is, preferably, substantially planar. The substantially planar body portion 2 can be modified to portray visual images of the desired waterfowl, game bird or other animal.

For example, screen printing methods well known in the art can be used to transfer such images to the body portion 2. Still further, such images could be transferred to a sheet of material, such as paper, vinyl, plastic, fabric, etc., which in turn could be attached to the body portion 2 using any suitable adhesive. The images transferred to the body portion 2 may be generated using any suitable technique known in the art, including photographic or computer-generated methods or hand-painting techniques. Non-limiting examples of the methods by which such images may be created and transferred to the body portion 2 of the present decoy are described in U.S. Pat. Nos. 5,293,709 and 6,115,953, which are hereby incorporated by reference in their entirety.

Importantly, the body portion 2 of the present decoy comprises an entirely separate component from the mounting post 5, which differs substantially from previous decoys developed by the inventors. More specifically, the previous decoys included a body portion and supportive means formed into a single component. The three-dimensional shape of the supporting means complicated the methods required to paint, or modify the appearance of, such decoys to resemble the desired waterfowl. Of course, the three-dimensional shape of the previous decoys further made screen printing the body portion impossible. Because the body portion 2 of the present invention is separable from the mounting post 5, the body portion 2 can be easily screen printed as described above or otherwise adapted to portray realistic bird- or animal-like images.

The body portion 2 of the present decoy is, preferably, interchangeable with the mounting post 5, which is substantially standardized or universal in shape, size, and structure. That is, the mounting post 5 of the present invention, preferably, may be used in connection with a plurality of decoy bodies. Thus, the “universal” nature of the mounting post simplifies the process by which a plurality of different decoys of the present invention are manufactured.

For example, in certain preferred embodiments, the “universal” mounting post 5 of the present invention may be mass produced. The mounting post 5 may then be used in connection with a plurality of different body portions 2 of the present decoy to construct a diverse array of decoys (or groups of decoys), each portraying different types of waterfowl, game birds, or the like. Of course, such embodiments provide more options to the end users of the present decoy, without significantly complicating manufacturing processes.

Still further, in other preferred embodiments, the mounting post 5 may, optionally, be purchased by hunters or other end users apart from the decoy body portion 2. This way, individual hunters or other end users could select the desired waterfowl, game bird, or other animal that he would like portrayed on his decoy 1 by simply purchasing the appropriate decoy body portion 2 from a plurality of options. It is further envisaged that end users may purchase a plurality of different body portions 2 to use in connection with a mounting post 5, wherein any given body portion 2 may be optimal for certain hunting seasons, weather, geographic locations, etc. Thus, the advantages of the “universal” mounting post 5 may be realized at the manufacturing stage and/or at the point-of-purchase by the end user.

The mounting post 5, of course, may be formed of any material known in the art, including plastic. In addition, those skilled in the art will appreciate that the mounting post 5 may take on any number of shapes and sizes, and is not limited to the specific mounting post shown and described herein. Rather, the present invention requires only that such mounting post 5 be substantially uniform in its three-dimensional structure, such that any appropriately configured body portion 2 may be attached thereto.

Still further, the mounting post 5 may portray any desired color or texture. In certain preferred embodiments, the color and/or texture of the mounting post 5 will be substantially consistent with the corresponding location of the body portion 2. Of course, in such embodiment, the interchangeable mounting post 5 would be “camouflaged” against the similarly colored and/or textured background of the body portion 2.

The body portion 2 may be affixed to the mounting post 5 in an attachment area using any suitable attachment means. The term “attachment area” includes, generally, any section of the mounting post 5 which receives, engages, or is adjoined with at least a part of at least one body portion 2. Thus, the present invention contemplates that the “attachment area” may comprise a plurality of different shapes, sizes, and structures. Of course, it is important that the “attachment area” of the mounting post 5 is capable of engaging the body portion 2.

In one embodiment, for example, the lateral passage of the body portion 2 may receive one side of the lateral wing support structure 8. In this example, the lateral passage of the body portion 2 engages a lip, channel, or like element in the lateral wing support structure to “snap” into position, which reversibly (or permanently) affixes the body portion 2 to the mounting post 5. Still further, the body portion 2 may engage the mounting post 5 by simply receiving one side of the lateral wing support structure 8, without any attachment means or fasteners. In such case, the body portion 2 would loosely hang upon the lateral wing support structure 8 of the mounting post 5.

In other, preferred embodiments of the invention, one side of the lateral wing support structure 8 of the mounting post 5 passes through the lateral passage in the body portion 2. The body portion 2 is then securely fastened to the attachment area of the mounting post 5 using an appropriate attachment means 22. Non-limiting examples of suitable attachment means include rivets, bolts, hitch pins, adhesives, or any other locking or fastening mechanisms. In certain preferred embodiments, the attachment means 22 may comprise a lip, channel, or like element to allow the body portion 2 to engage the mounting post 5 and “snap” into position. Of course, it is contemplated that the attachment means 22 may be permanent or reversible. If the attachment means 22 is reversible, end users could easily engage and disengage the body portion 2 from the mounting post 5.

Each of the wing vanes 3 and 4 is, preferably, formed of a thin, rigid sheet of material. Plastic sheet, preferably, is used to form the wing vanes 3 and 4, as it is relatively inexpensive, resistant to corrosion, and is easily formed to have the desired aerodynamic shape for operation in relatively light breezes. Other materials (e.g., properly protected aluminum sheet, etc.) may be used as desired. The two wing vanes 3 and 4, preferably, are colored, textured, and/or patterned to represent the waterfowl or game bird depicted by the body portion 2.

The lateral wing support structure 8 passes laterally through the mounting post 5, for supporting a wing shaft 13 which may be removably installed therein. The lateral wing support structure 8 is preferably formed integrally with the mounting post 5, when such mounting post is cast or molded.

Each of the two wing vanes 3 and 4 includes a generally circular channel, respectively 9 and 12. The two wing channels 9 and 12 may, optionally, span the entire width of the wing vanes 3 and 4 or less than the entire width (as shown in FIG. 1). The two wing channels 9 and 12 may, optionally, be used for securing first and second wing shaft tubes, respectively 11 and 10, therein. The two wing shaft tubes 11 and 10 may be permanently and immovably affixed within their respective wing channels 9 and 12, e.g., by blind rivets or by other suitable means (screws, bolts, adhesives, etc.). The two wing shaft tubes 11 and 10 may receive and secure the wing shaft 13 to which the wing vanes 3 and 4 are attached.

In certain preferred embodiments, however, the two wing channels 9 and 12 are capable of receiving and securing the wing shaft 13. In such embodiments, of course, the two wing shaft tubes 11 and 10 are not required. More specifically, in such embodiments, the first wing channel 9 permanently and immovably receives the wing shaft 13, which extends concentrically from the channel 9. The wing shaft 13 has a distal second wing vane attachment end 14, and serves as the central support for the two wing vanes 3 and 4. A portion of the wing shaft 13 passes through the lateral wing support structure 8 at one side of the mounting post 5, and extends outwardly therefrom past the second side of the mounting post 5.

The second wing channel 12 installs concentrically over the distal second wing vane attachment end 14 of the wing shaft 13, and is immovably secured thereto by a hitch pin 15 or the like which installs removably through corresponding holes 16 and 17 formed diametrically through the distal end of the wing shaft 13 and root end of the second wing channel 12. Of course, while a hitch pin 15 has been found to sufficiently secure the wing shaft 13 to the second wing channel 12, those skilled in the art will appreciate that any suitable attachment means could be used for such purpose. The present decoy 1 is therefore easily disassembled for compact storage by removing the hitch pin 15, removing the second wing channel 12 from the wing shaft 13, and withdrawing the wing shaft 13 from the lateral wing support structure 8 of the mounting post 5.

In certain alternative embodiments, the wing vanes 3 and 4 are both removable from the wing shaft 13—similar to wing vane 4 in the previously described embodiment. Of course, such embodiments would also allow for quick disassembly of the decoy for compact storage. Still further, it is contemplated that both wing vanes 3 and 4 may be permanently installed upon the wing shaft 13. In this embodiment, the lateral wing support structure 8 of the mounting post 5 must be configured to receive such wing shaft and wing vane assembly. For example, instead of the lateral wing support structure 8 comprising a cylindrical-like shape (shown in FIGS. 2 and 3), it would exhibit a slot, channel, or any other space capable of receiving the wing shaft 13. In such embodiment, for example, the lateral wing support structure 8 may comprise a channel that runs the length of the structure 8 on its dorsal side, wherein the wing shaft 13 could be rotatably installed therein.

The aerodynamic shapes of the two wing vanes 3 and 4 capture the wind and produce rotation of the two wing vanes 3 and 4 about the lateral axis 18 defined by the wing shaft 13 passing through the lateral wing support structure 8 of the mounting post 5. Ball bearings 19, or other suitable bearings (e.g. roller, needle, etc.), are preferably installed within the structure 8 in order to reduce friction to the greatest practicable degree and to allow rotation of the wing vanes 3 and 4 in the slightest breezes. However, plain sleeve bearings may be used if so desired, although the greater friction of such plain bearings results in a need for greater wind velocity for rotation of the wing vanes 3 and 4.

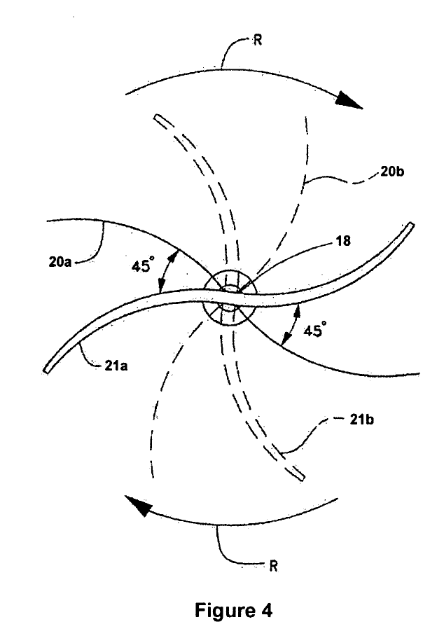

FIG. 4 illustrates the general chordwise shape of the two wing vanes, as well as their angular offset from one another about their common lateral axis. The two wing vanes are each shown in two different positions, in order to show their rotational movement as they are actuated by the wind. The first position for each vane is shown in solid lines, i.e., vanes 20a and 21a, while the second position is illustrated by broken lines, i.e., vanes 20b and 21b. The orientation of FIG. 4 is from the right side of the decoy 1, i.e., from the side having the second wing vane 4 extending therefrom. The first wing vane 20a, 20b is illustrated by a single line in FIG. 4, while the second wing vane 21a, 21b is illustrated as having a finite thickness with separate lines designating the opposite surfaces, in order to distinguish the two wing vanes 20a, 20b and 21a, 21b from one another in FIG. 4.

The two wing vanes of the decoy, preferably, have substantially identical airfoil shapes, i.e., each has a substantially sinusoidal cross sectional shape extending along its chord from one edge to the other. This combination of concave and convex shape to each side of the central lateral axis 18 of rotation defined by the wing shaft 13, produces differential lifting forces upon each side of the wing vane from the lateral axis 18 under most vane angles. However, as the vanes are symmetrical, there will be certain angles of attack at which the aerodynamic forces are balanced for each, thus canceling rotational forces for that particular wing vane.

To overcome this problem, the two wing vanes 3 and 4 are, preferably, installed upon their common wing shaft 13 with some angular displacement about their common rotational axis. This is shown clearly in FIG. 4, with a forty five degree angle between the first positions 20a, 21a of the two vanes and thus also between their second positions 20b, 21b. Thus, if one of the vanes, e.g., the second vane as shown by its first position 21a, has balanced aerodynamic forces thereon with no resulting pitching moment about the rotational axis, the opposite vane, e.g., the first vane 20a, will be positioned to produce a net aerodynamic force and thereby produce rotation of the assembly. As the first vane 20a rotates to a position where the aerodynamic forces are neutralized, it will automatically rotate the joined second vane to some other angular position whereby aerodynamic forces will produce a pitching moment and rotation of that vane. Continuous rotation of the wing vane assembly 3 and 4 is thus optimized for any suitable breeze.

While the inventors have found that a forty five degree angle between the wing vanes 3 and 4 is desired, the invention contemplates that any other angular disposition could also be used. In fact, if desired, the invention contemplates that any angular position of the wing vanes 3 and 4 from 0° to 179° in either direction could be employed.

The relative angular position of the wing vanes 3 and 4 can be fixed in any manner known in the art. For example, the wing shaft 13 may be immovably affixed to the wing channel 9. The wing shaft 13 may be immovably affixed to the wing channel 9, and thus, to wing vane 3, in such manner using any suitable means, e.g., blind rivets, screws, bolts, adhesives, etc. After the wing shaft 13 is passed through the lateral wing support structure 8, the second wing channel 12 may be installed concentrically over the distal second wing vane attachment end 14 of the wing shaft 13, and immovably secured thereto by the hitch pin 15 or the like, which installs removably through corresponding holes 16 and 17 formed diametrically through the distal end of the wing shaft 13 and root end of the second wing channel 12. In this example, the location of the corresponding holes 16 and 17 along the circumference of the wing shaft 13 and wing channel 12, respectively, is such that once the hitch pin 15 is inserted therein, the approximate plane of the permanently affixed wing vane 3 is set to the desired angular position from the approximate plane of wing vane 4. Of course, it will be obvious to those skilled in the art that other means for fixing the angular separation between vanes 3 and 4 may be used consistent with the teachings of the present invention.

The present wind activated decoy 1 is also provided with means to allow the decoy to pivot into the prevailing wind. The decoy 1 is mounted slightly above the underlying terrain or surface by means of a pivot support tube 7, as noted further above. The mounting post 5 of the decoy 1 includes an integral pivot support shaft 6, which fits within the pivot support tube 7. The pivot support shaft 6, preferably, has a diameter configured to fit smoothly within the interior of the pivot support tube 7.

The decoy 1 is used by driving the support tube 7 into the underlying surface, e.g., dry hunting ground, marsh, or pond bottom, etc., with the upper end positioned just above the surface. The wing vanes, 3, 4 are installed upon the decoy 1 or, specifically, to the mounting post 5 as described further above. The pivot support shaft 6 is placed into the open upper end of the support tube 7. As the pivot support shaft 6 is positioned ahead of the aerodynamic center of pressure of the decoy 1, with the aerodynamic drag of the wing vanes 3 and 4 disposed behind the pivot shaft 6, the decoy assembly 1 will turn into the prevailing wind, since torque applied by the wind acts behind the pivot point.

In light of the foregoing, the present wind activated decoy provides realistic action while at the same time providing superior economy and variety of purchase over more complex mechanized decoys. The action of the rotating wing vanes provides an appearance that resembles the rapid flapping action of a waterfowl or game bird about to alight upon a surface (pond, etc.). This is particularly true when the opposite surfaces of the wing vanes of the present decoy are patterned or marked as described above to represent the upper and lower wing surfaces of a bird, with their different colors and markings. Although the wing vanes of the present decoy rotate rather than flap, such rotation from afar resembles a rapid flapping action. The appearance of such an apparent rapid flapping action is indicative of birds alighting upon a surface, and can serve to entice other birds to land in the same area.

The provision of the forwardly mounted pivot shaft adds further realism, by allowing the decoy to pivot freely into the prevailing wind. This provides two benefits: (1) it assures that the wing vanes are aligned perpendicular to the wind direction for optimum efficiency, and (2) it serves to align the decoy into the wind to simulate the actions of a real game bird or waterfowl, which by their nature tend to align themselves with the prevailing wind. The realism of the present decoy, even with its economical profile construction, thus serves as an economical means of attracting game birds and waterfowl for hunters, photographers, and others having similar interests.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

1. A wind activated decoy, which comprises: (i) a mounting post comprising a support shaft and a lateral wing support structure; (ii) a body portion capable of being attached to said mounting post, wherein said body portion portrays the shape and image of a desired species; and (iii) two wing vanes, wherein said wing vanes are connected by a wing shaft.

2. The wind activated decoy according to claim 1, wherein each of said wing vanes comprises an approximately sinusoidal curve in cross section for producing aerodynamic rotation thereof when acted upon by the wind.

3. The wind activated decoy according to claim 1, wherein said lateral wing support structure comprises ball bearings disposed therein for rotatably supporting said wing shaft.

4. The wind activated decoy according to claim 1, wherein said body portion pivotally turns upon said support shaft to orient said wing vanes into prevailing wind.

5. The wind activated decoy according to claim 1, wherein said body portion is reversibly attached to said mounting post.

6. The wind activated decoy according to claim 1, wherein said body portion is permanently attached to said mounting post.

7. The wind activated decoy according to claim 1, wherein said image of a desired species is screen printed on said body portion.

8. The wind activated decoy according to claim 7, wherein said image is a photographic rendering of said desired species.

9. The wind activated decoy according to claim 7, wherein said image is a hand-painted rendering of said desired species.

10. The wind activated decoy according to claim 7, wherein said image is a computer-generated rendering of said desired species.

11. The wind activated decoy according to claim 1, wherein said image of a desired species is adhesively attached to said body portion.

12. A wind activated decoy, which comprises: (i) a mounting post comprising a support shaft and a lateral wing support structure; (ii) a body portion comprising a substantially thin, rigid sheet of material, wherein said body portion is capable of being attached to said mounting post and portrays the shape and image of a desired species; and (iii) two wing vanes, wherein said wing vanes are connected by a wing shaft.

13. The wind activated decoy according to claim 12, wherein each of said wing vanes comprises an approximately sinusoidal curve in cross section for producing aerodynamic rotation thereof when acted upon by the wind.

14. The wind activated decoy according to claim 13, wherein said body portion pivotally turns upon said support shaft to orient said wing vanes into prevailing wind.

15. The wind activated decoy according to claim 14, wherein said image of a desired species is screen printed on said body portion.

16. A mounting post for supporting the body portion of a wind activated decoy, which comprises: (i) an attachment area,. which receives said body portion of said decoy; (ii) a support shaft upon which said decoy is capable of pivoting into a prevailing wind; and (iii) a lateral wing support structure, which is capable of housing a wing shaft upon which at least two wing vanes of said decoy rotate.

17. The mounting post of claim 16, wherein said body portion is permanently affixed to said attachment area.

18. The mounting post of claim 16, wherein said body portion is reversibly affixed to said attachment area.

19. A wind activated decoy kit, which comprises (i) the mounting post according to claim 16 and (ii) a wing shaft, wherein said wing shaft is capable of rotating within the lateral wing support structure of said mounting post.

20. The wind activated decoy kit according to claim 19, which further comprises at least two wing vanes capable of engaging said wing shaft.

21. The wind activated decoy kit according to claim 20, which further comprises the body portion of said decoy, wherein said body portion comprises a substantially thin, rigid sheet of material capable of being attached to said mounting post and portrays the shape and image of a desired species.
